(19) United States
(12) Patent Application Publication
(10) Pub. No.: US 2022/0124986 A1
(43) Pub. Date: Apr. 28, 2022

(54) FIXING STRUCTURE FOR COLLECTING AND ASSEMBLING FLOWER

(71) Applicant: CHU HSING METAL CO., LTD., Changhua County (TW)

(72) Inventor: Kuan-Chuan WANG, Changhua County (TW)

(21) Appl. No.: 17/077,789

(22) Filed: Oct. 22, 2020

(51) Int. Cl. A01G 9/02; A01G 9/12; A01G 9/28

(52) U.S. Cl. CPC A01G 9/02; A01G 9/28; A01G 9/12

(57) ABSTRACT

A fixing structure for collecting and assembling flower, especially used for collecting and placing potted plants such as potted orchids, includes a rectangular flower holder main body and a height elevating rack used for allowing a height of the flower holder main body to be elevated, at least one set of two rows of position limiting members arranged in a pairing means are disposed in the flower holder main body; each position limiting member arranged at two sides of the flower holder main body has a concave arc-shaped abutting surface formed at an inner side thereof, and two adjacent surface of the other position limiting members are respectively formed with a concave arc-shaped abutting surface, so that an accommodating slot zone can be defined by each set of the four corresponding concave arc-shaped abutting surfaces, thereby enabling potted plants to be formed as a bonsai.

### BACKGROUND OF THE INVENTION

### Field of the Invention

The present invention relates to a fixing structure for collecting and assembling flower, in which position limiting members and concave arc-shaped abutting surfaces are deigned and arranged in a flower holder main body, so that accommodating slot zones consisted of the concave arc-shaped abutting surfaces allow potted plants such as potted orchids to be placed for structuring an assembled flower bonsai, thereby enabling the assembling operation of the flower bonsai to be faster and easier, and the problems and disadvantages existed in the conventional operation modes are solved. Fixing the potted plants can be effectively finished, and the problems and disadvantages.

### Description of Related Art

Generally, fresh flower bonsai are used on occasions such as a wedding, a funeral, a new housing party or a grand opening of a company, and fresh flowers are commonly used for decorating the occasions, wherein orchids are adopted as the above-mentioned flower bonsai. Speaking of the planting of orchid, a soft pot planting means is often adopted, when a flower bonsai is desired to be collected and assembled, a predetermined amount of the orchids are selected according to actual needs so as to be integrally assembled in a proper flower holder, meanwhile a growing status of flower spikes shall be put in considers for being properly adjusted and matched so as to provide a better visual effect, thereby achieving an objective of assembling the desired flower bonsai.

In the collecting and assembling operation of the flower bonsai, a flowerpot having a proper size is selected as the flower holder for providing a magnificent sensation and atmosphere; because the size of the flower holder is very different from that of the potted orchid, other materials or wastes, for example styrofoam or waste fabrics, are required to be firstly disposed in the flower holder for filling gaps before the potted orchids are disposed in the flower holder so as to prevent a displacing situation; because the assembling and positioning operation is complicated, and directions of flower spikes of the potted orchids are required to be frequently adjusted, an experienced personnel is need for achieving the assembly and adjustments.

In view of the above, the collecting and assembling operation for the fresh bonsai, for example the orchid bonsai, can only be achieved by the experienced personnel, thus the labor cost is inevitably high; moreover, the means of filling different materials in the flower holder would cause the material cost and the environmental protection issues, the flower holder is formed through a ceramic material being processed with a firing treatment, thus the cost is high, and another problem of subsequent transportation and process shall also be concerned, accordingly, the above-mentioned shortages and disadvantages shall be improved by the skilled people in the art.

### SUMMARY OF THE INVENTION

In view of the conventional collecting and assembling operation for the flower bonsai, the flower holder is not provided with a fixing structure and different materials are required to be fill for increasing the height and fixing the potted orchids, so that only the experienced personnel can perform the operation; based on the above-mentioned shortages and disadvantages, the applicant of the present invention has devoted himself for developing a fixing structure for collecting and assembling flower having advantages of being fast and easy.

For satisfying a positioning requirement of the potted orchid while being collected and assembled, the present invention disclosed a fixing structure for collecting and assembling flower, and a structural design of forming a plurality of position limiting members in a flower holder main body and forming accommodation slot zones through concave arc-shaped abutting surfaces is provided for allowing potted plants, for example potted orchids, to be placed and directly positioned, thereby achieving an objective of structuring an assembled flower bonsai.

According to the fixing structure for collecting and assembling flower provided by the present invention, the accommodating slot zones consisted of the plurality of position limiting members are arranged in the flower holder main body thus there is no need of any filling material or wastes, thus the placing assembly can be easier to be achieved, and no professional personnel is required for the operation, thereby greatly reducing the material cost and the labor cost, meanwhile the flower holder main body is recyclable, so that problems and disadvantages existed in the conventional operating modes can be effectively solved.

### BRIEF DESCRIPTION OF THE DRAWINGS

FIG. 1 is an exploded view showing the whole structure according to one preferred embodiment of the present invention;

FIG. 2 is a schematic view showing the structure of the flower holder main body according to one preferred embodiment of the present invention;

FIG. 3 is a top view showing the structure of the flower holder main body according to one preferred embodiment of the present invention;

FIG. 4 is a partial cross sectional view showing the structure of the flower holder main body according to one preferred embodiment of the present invention;

FIG. 5 is another schematic view showing the structure of the flower holder main body according to one preferred embodiment of the present invention;

FIG. 6 is a schematic view showing an operating status according to one preferred embodiment of the present invention;

FIG. 7 is a schematic view showing an operating status being provided with the textile according to one preferred embodiment of the present invention; and

FIG. 8 is a schematic view showing the structural relation according to another preferred embodiment of the present invention.

### BRIEF DESCRIPTION OF CODES

(10): Flower holder main body
(11): Position limiting member
(12) (13): Concave arc-shaped abutting surface
(14): Annular recess
(20): Height elevating rack
(30): Potted plant
(40): Textile

### DETAILED DESCRIPTION OF THE PREFERRED EMBODIMENT

Preferred embodiments of the present invention will be described with reference to the drawings for illustrating the structural assembly, the technical means and the functions to be achieved by the present invention; and the actual ratios and the arrangement of components shall not be limited by the ratios and the arrangement of components in the provided figures.

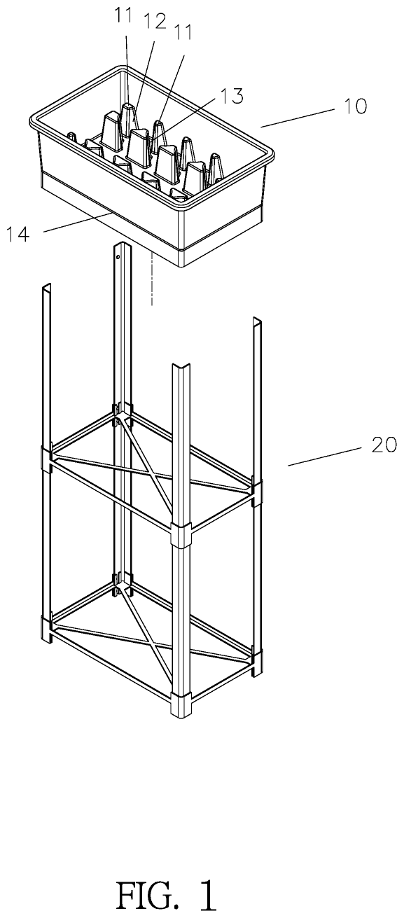

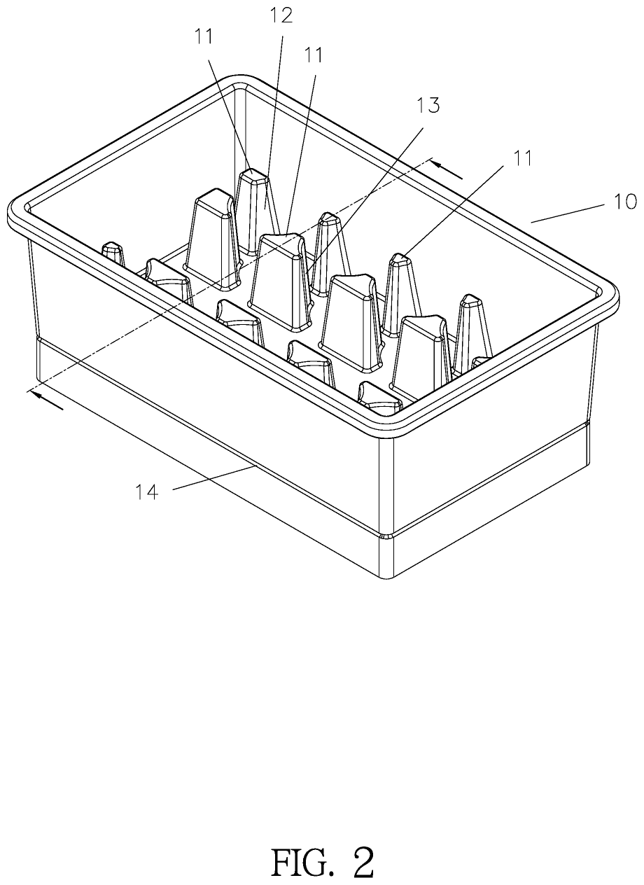

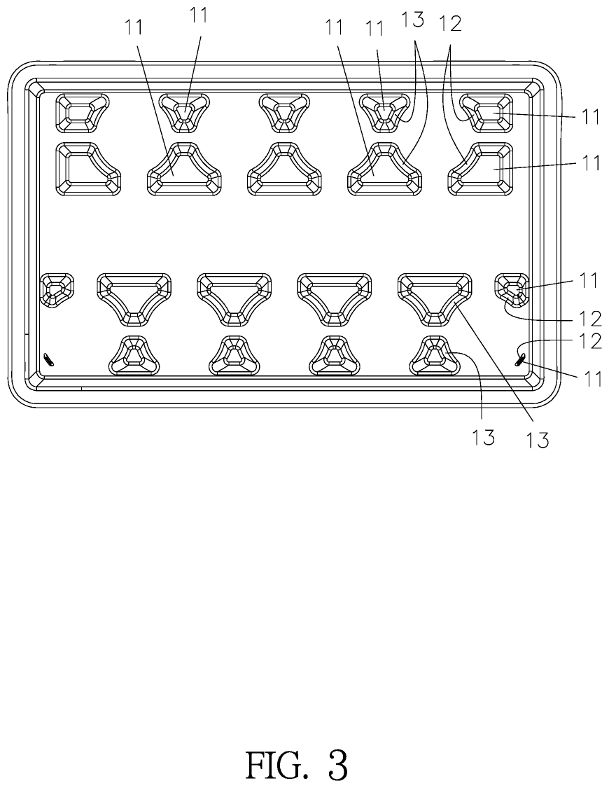

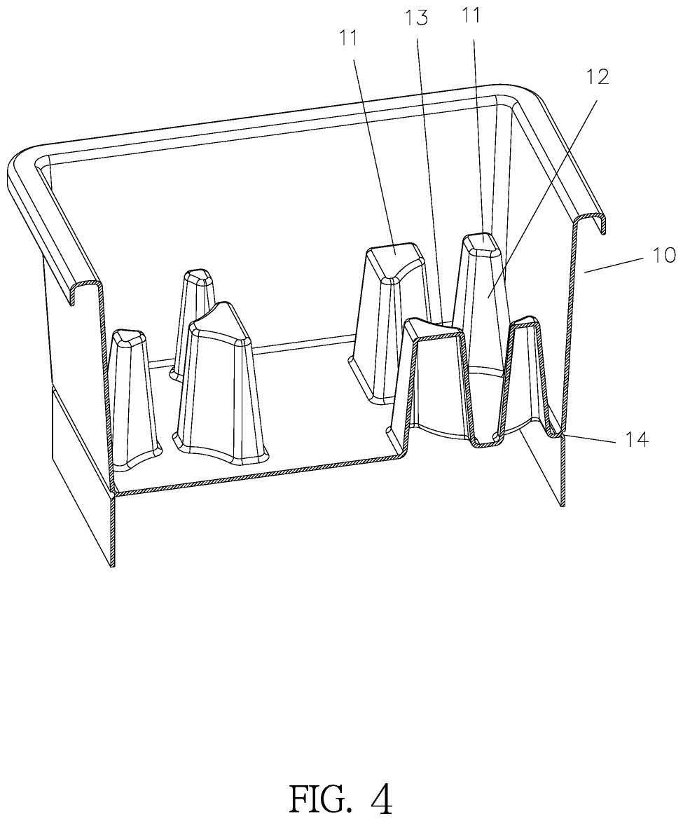

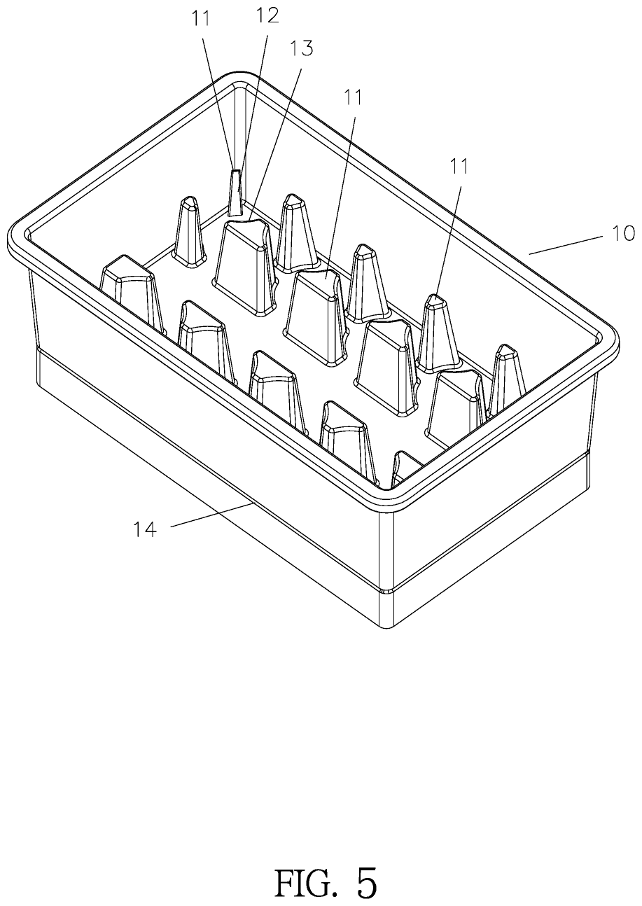

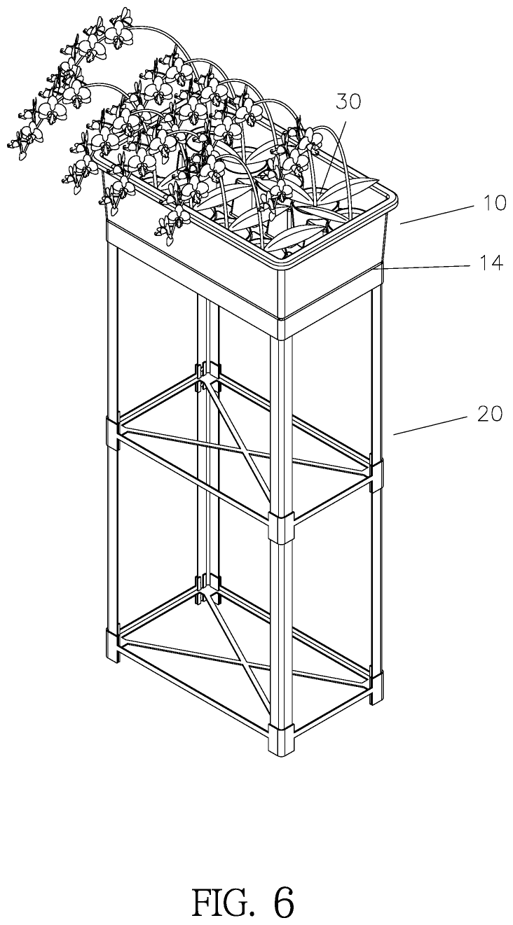

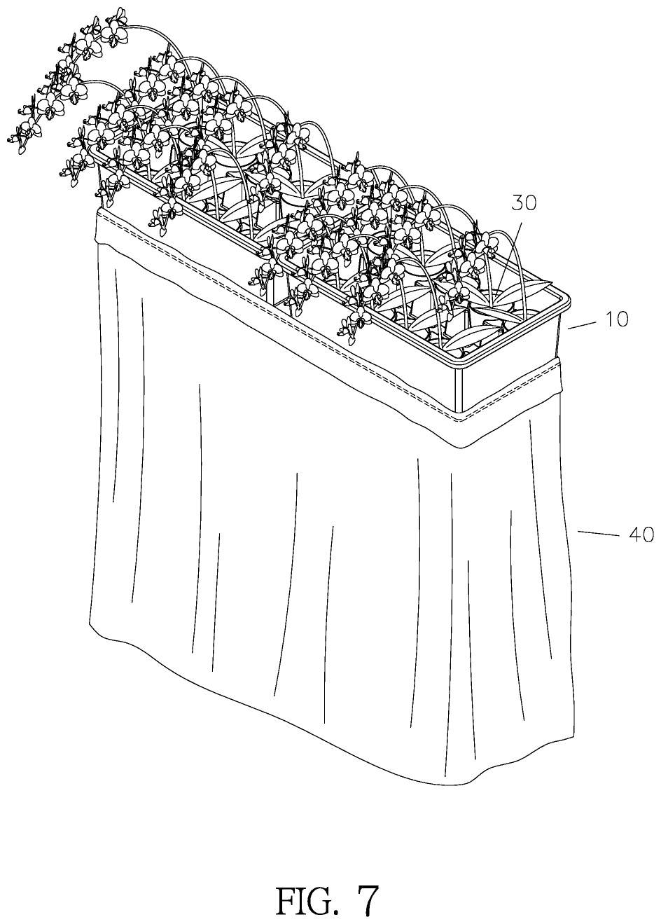

Please refer from FIG. 1 to FIG. 7, according to one preferred embodiment of the present invention, a fixing structure for collecting and assembling flower including a flower holder main body (10) and a height elevating rack (20) is disclosed. According to a structural design provided by the present invention, the flower holder main body (10) is formed as a rectangular or square flowerpot so as to be easily arranged and combined, the height elevating rack (20) is used for elevating the height of the flower holder main body (10), at least one set of two rows of position limiting members (11) arranged in a pairing means (two sets of four rows of position limiting members as shown in figures) are disposed in the flower holder main body (10), the position limiting members (11) can be formed with different dimensions or statuses with respect to different arranged locations (as shown in figures, the position limiting members being close to a central portion being formed as larger conical members, that being close to a lateral sides being formed as smaller conical members, and that being close to two sides being formed as trapezoid conical members or sheet-like members), when the set amounts of the position limiting members (11) are greater than two, each set of the position limiting members (11) are arranged in a staggering means (as shown in figures); each set of the position limiting members (11) arranged at two sides of the flower holder main body (10) has a concave arc-shaped abutting surface (12) formed at an inner side of the position limiting member (11), and two adjacent surface of the other position limiting members (11) are respectively formed with a concave arc-shaped abutting surface (13), a top end of each of the concave arc-shaped abutting surfaces (12) (13) of each of the position limiting members (11) is respectively formed in an outwardly-expanding conical status, so that an accommodating slot zone can be defined by each set of the four corresponding concave arc-shaped abutting surfaces (12) (13) so as to allow a potted plant (30), for example a potted orchid, to be selectively disposed, and a positioning effect is also provided to the potted plant (30), thereby enabling the potted plant (30) to be formed as a bonsai, a lower portion defined at an outer edge of the flower holder main body (10) is preformed with an annular recess (14), a bottom end of the flower holder main body (10) is enclosed by utilizing a textile (40) for a purpose of enclosing the height elevating rack (20), thereby increasing the whole visual effect.

Based on what has been disclosed above, when a flower collecting and assembling operation is desired to be processed, a plurality of the potted plants (30), for example the potted orchids, are selectively disposed in the accommodating slot zones arranged in the flower holder main body (10), and directions of flower spikes of the potted plants (30) are properly adjusted, meanwhile a plurality of the flower holder main bodies (10) can be combined as a row for structuring a large assembled flower bonsai according to actual requirements, thus advantages of being fast and easy in operation are provided, and no filling material or wastes, for example styrofoam or waste fabrics, is needed, meanwhile there is no need of a professional personnel for operations, thereby greatly reducing the whole cost and solving problems and disadvantages existed in assembling the conventional large flower bonsai.

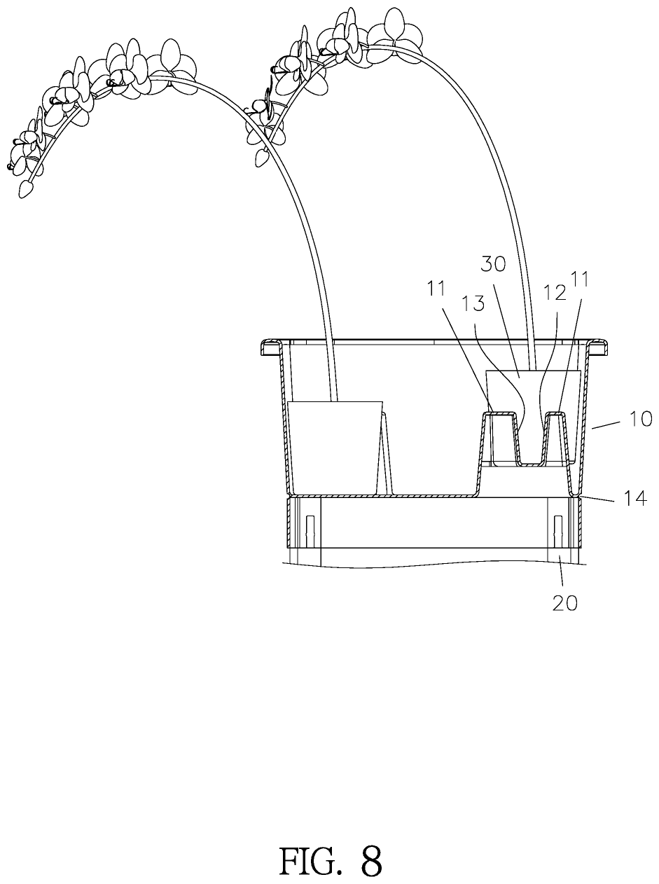

Please refer to FIG. 8, which discloses another preferred embodiment of the present invention, under a functional frame of the accommodating slot zones consisted of the concave arc-shaped abutting surfaces (12) (13) of the plurality of position limiting members (11) arranged in the flower holder main body (10), the present invention provides a feature of allowing bottom ends of the accommodating slot zones consisted of the concave arc-shaped surfaces (12) (13) of the plurality of position limiting members (11) to be arranged in various status, so that each of the accommodating slot zones has height difference, when the potted plants (30) are placed, a natural height differentia effect can be provided, thereby greatly increasing the alternatives of the whole visual effects of the large flower bonsai and satisfying the placing requirements on different occasions.

As such, based on what has been disclosed above, according to the present invention, the plurality of accommodating slot zones consisted of the plurality of position limiting members having different dimensions and status arranged in the flower holder main body allow the potted plants to be provided with a desired positioning design, and a problem of accidently being damaged due to collisions while being transported can be prevented and the placing and assembling operation of the potted plants, for example the potted orchids, can be faster and easier, and no additional filling material, for example the styrofoam, is needed, and there is no need of the professional personnel for the whole assembling operations; accordingly, the present invention is more practical in use and more suitable to be applied in industrial use comparing to the conventional assembling means of large flower bonsai.

Based on what has been disclosed above, the fixing structure for collecting and assembling flower provided by present invention utilizes the accommodating slot zones consisted of the plurality of position limiting members arranged in the flower holder main body, there is no need of the professional personnel for selectively placing the potted plants, for example the potted orchids, in the desired accommodating slot zones, so that the collecting, assembling and fixing the potted plants can be effectively finished, and the problems and disadvantages existed in the conventional structure can be completely solved; accordingly, the present invention is novel in design, more practical in use and more suitable to be applied in industrial use comparing to prior arts.

What is claimed is:

1. A fixing structure for collecting and assembling flower, including a flower holder main body and a height elevating rack, wherein the flower holder main body is formed as a rectangular or square flowerpot so as to be easily arranged and combined, the height elevating rack is used for elevating a height of the flower holder main body; and characterized in that:
at least one set of two rows of position limiting members arranged in a pairing means are disposed in the flower holder main body, the position limiting members are able to be formed with different dimensions or statuses with respect to different arranged locations, when the set amounts of the position limiting members are greater than two, each set of the position limiting members are arranged in a staggering means; each set of the position limiting members arranged at two sides of the flower holder main body has a concave arc-shaped abutting surface formed at an inner side of the position limiting member, and two adjacent surface of the other position limiting members are respectively formed with a concave arc-shaped abutting surface, so that an accommodating slot zone can be defined by each set of the four corresponding concave arc-shaped abutting surfaces so to allow a potted plant to be selectively disposed, and a positioning effect is also provided to the potted plant, thereby forming the fixing structure for collecting and assembling flower having an advantage of being easily to be assembled and fixed.

2. The fixing structure for collecting and assembling flower as claimed in claim 1, wherein a lower portion defined at an outer edge of the flower holder main body is preformed with an annular recess, a bottom end of the flower holder main body is enclosed by utilizing a textile for a purpose of enclosing the height elevating rack, thereby increasing the whole visual effect.

3. The fixing structure for collecting and assembling flower as claimed in claim 1, wherein among the position limiting members arranged in the flower holder main body, the position limiting members being close to a central portion are formed as larger conical members, the position limiting members being close to a lateral sides are formed as smaller conical members, and the other position limiting members being close to two sides are formed as trapezoid conical members or sheet-like members.

4. The fixing structure for collecting and assembling flower as claimed in claim 1, wherein a top end of each of the concave arc-shaped abutting surfaces of each of the position limiting members arranged in the flower holder main body is respectively formed in an outwardly-expanding conical status.

5. The fixing structure for collecting and assembling flower as claimed in claim 1, wherein bottom ends of the accommodating slot zones consisted of the concave arc-shaped surfaces of the plurality of position limiting members arranged in the flower holder main body are arranged in various status, so that each of the accommodating slot zones has height difference, when the potted plants are placed, a natural height differentia effect is provided.
